(19) United States
(12) Patent Application Publication
(10) Pub. No.: US 2013/0321304 A1
(43) Pub. Date: Dec. 5, 2013

(54) TOUCH PANEL, MANUFACTURING METHOD THEREOF AND DISPLAY DEVICE USING THE SAME

(71) Applicant: Innolux Corporation, Miao-Li County (TW)

(72) Inventor: Chung-Kai Wang, Miao-Li County (TW)

(73) Assignee: Innolux Corporation, Miao-Li County (TW)

(21) Appl. No.: 13/893,387

(22) Filed: May 14, 2013

(30) Foreign Application Priority Data
May 31, 2012 (TW) 101119513

(51) Int. Cl. H01H 9/12; H01H 11/00

(52) U.S. Cl. CPC H01H 9/12; H01H 11/00
USPC 345/173; 200/305; 29/622

(57) ABSTRACT

A touch panel, a manufacturing method and a display device using the same are provided. The touch panel includes a substrate, a conductive layer, an insulating layer, a shielding layer and a flexible printed circuit board. The conductive layer is disposed on the substrate. The insulating layer is disposed on the conductive layer. The shielding layer is disposed on the insulating layer. The flexible printed circuit board has a ground trace electronically connected to the conductive layer. The shielding layer is electronically connected to the ground trace through at least one conductive through hole.

This application claims the benefit of Taiwan application Serial No. 101119513, filed May 31, 2012, the subject matter of which is incorporated herein by reference.

### BACKGROUND OF THE INVENTION

1. Field of the Invention

The invention relates in general to a panel, a manufacturing method and an electronic device using the same, and more particularly to a touch panel, a manufacturing method and a display device using the same.

2. Description of the Related Art

Along with the advance in technology, a touch panel is provided. The touch panel senses the movement or clicking made by a finger or an object, and allows the user to operate more intuitively.

Touch panel has been widely used in various types of display device such as tablet PC display or smart phone display. Referring to FIG. 1, a schematic diagram of a generally known display device 3000 is shown. The display device 3000 includes a touch panel 500 and a display panel 600. The touch panel 500, when interfered with by the signal of the display panel 600, may easily make erroneous judgment. Therefore, a shielding layer 540 is normally disposed between the touch panel 500 and the display panel 600 to isolate the signal interference of the display panel 600. In general, the shielding layer 540 is grounded, and the touch panel 500 transmits the sensed touch signal to a processing unit through a flexible printed circuit board 550. Thus, the flexible printed circuit board 550 is respectively connected to the touch panel 500 and the shielding layer 540. Since the flexible printed circuit board 550 is respectively connected to the touch panel 500 and the shielding layer 540 by way of thermoforming, the touch panel 500 may be damaged and the conformity rate will deteriorate. Therefore, it has become a prominent task for the industries to provide alternative connection method of the flexible printed circuit board 550 to increase product reliability.

### SUMMARY OF THE INVENTION

The disclosure is directed to a touch panel, a manufacturing method and a display device using the same. Through the design of a conductive through hole, the flexible printed circuit board does not need to go through thermoforming process twice, hence increasing product reliability.

According to an embodiment of the present disclosure, a touch panel is provided. The touch panel includes a substrate, a conductive layer, an insulating layer, a shielding layer and a flexible printed circuit board. The conductive layer is disposed on the substrate. The insulating layer is disposed on the conductive layer. The shielding layer is disposed on the insulating layer. The flexible printed circuit board has a ground trace electronically connected to the conductive layer. The shielding layer is electronically connected to the ground trace through at least one conductive through hole.

According to another embodiment of the present disclosure, a manufacturing method of touch panel is provided. The manufacturing method of touch panel includes the following steps. A substrate is provided. A conductive layer is formed on the substrate. An insulating layer and a shielding layer are formed on the conductive layer. The shielding layer is disposed on the insulating layer. A flexible printed circuit board is connected to the conductive layer, wherein the flexible printed circuit board has a ground trace, so that the ground trace is electronically connected to the conductive layer. At least one conductive through hole is formed, so that the shielding layer is electronically connected to the ground trace of the flexible printed circuit board through the conductive through hole.

According to an alternate embodiment of the present disclosure, a display device is provided. The display device includes a display panel and a touch panel. The touch panel includes a substrate, a conductive layer, an insulating layer, a shielding layer and a flexible printed circuit board. The conductive layer is disposed on the substrate. The insulating layer is disposed on the conductive layer. The shielding layer is disposed on the insulating layer. The flexible printed circuit board has a ground trace electronically connected to the conductive layer. The shielding layer is electronically connected to the ground trace through at least one conductive through hole.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of a generally known display device;

FIG. 2 shows a top view of a display device;

FIG. 3 shows a cross-sectional view of a display device of FIG. 1 along a cross-sectional line 3-3;

FIGS. 4A to 4E are processes illustrating a manufacturing method of a touch panel according to a first embodiment;

FIG. 5 shows a cross-sectional view of a display device according to the second embodiment; and

FIGS. 6A to 6B are processes illustrating a manufacturing method of a touch panel according to a second embodiment.

### DETAILED DESCRIPTION OF THE INVENTION

A number of embodiments are disclosed below for elaborating the disclosure. Through the design of a conductive through hole, the flexible printed circuit board does not need to go through thermoforming process twice, hence increasing product reliability. However, the embodiments of the disclosure are for detailed descriptions only, not for limiting the scope of protection of the disclosure. Furthermore, secondary or unimportant elements are omitted in the accompanying diagrams of the embodiments for highlighting the technical features of the disclosure.

### First Embodiment

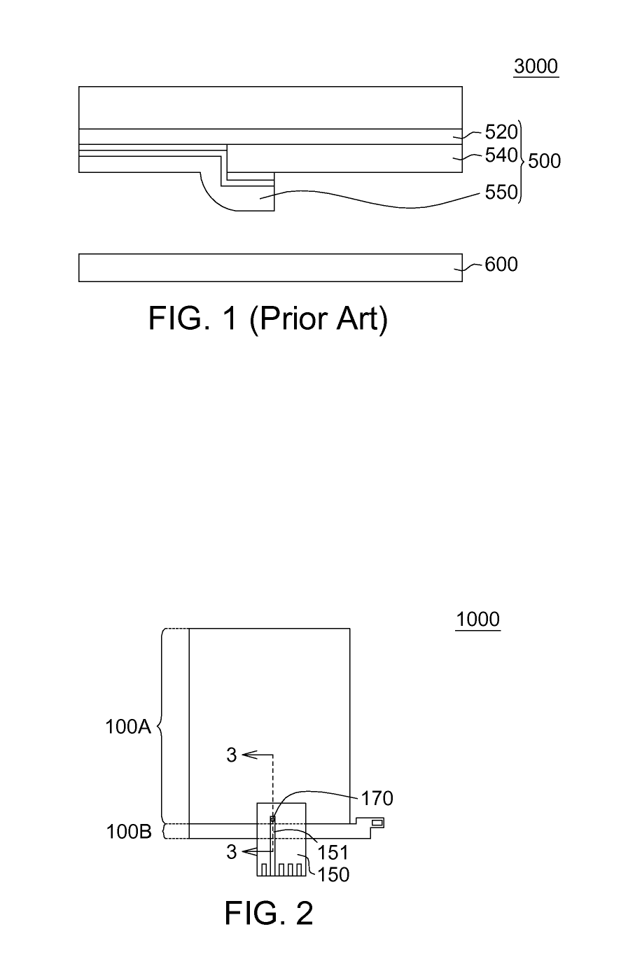

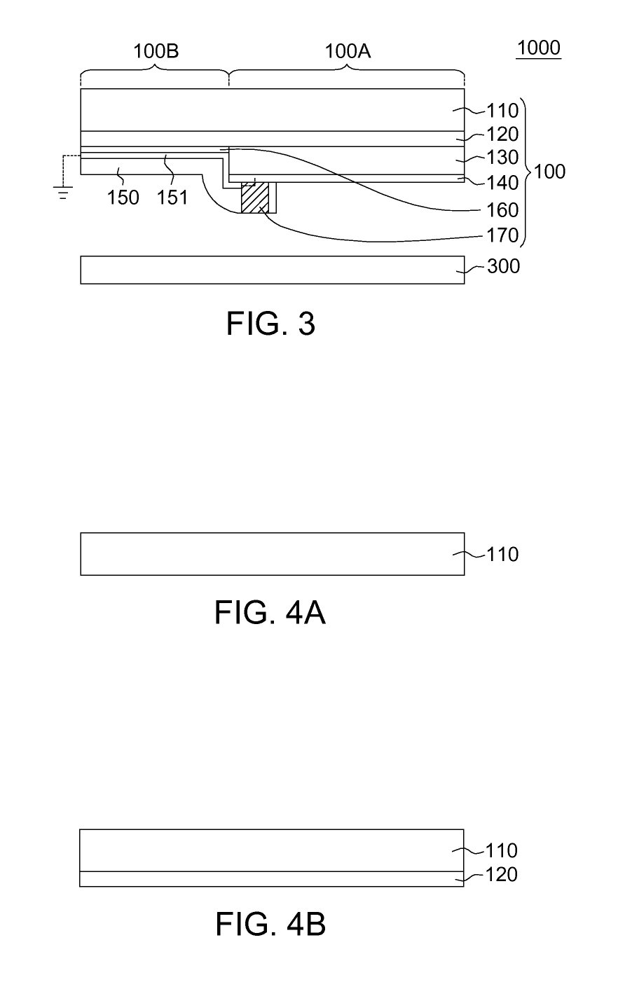

Referring to FIGS. 2 to 3, FIG. 2 shows a top view of a display device 1000. FIG. 3 shows a cross-sectional view of a display device 1000 of FIG. 1 along a cross-sectional line 3-3. The display device 1000 includes a touch panel 100 and a display panel 300. The touch panel 100 has a touch area 100A and a circuit area 100B. The touch area 100A has a sensing circuit for sensing a touch signal triggered by a finger or an object. The circuit area 100B transmits the touch signal to a processing unit (not illustrated).

Referring to FIG. 3, the touch panel 100 includes a substrate 110, a conductive layer 120, an insulating layer 130, a shielding layer 140 and a flexible printed circuit board 150. The substrate 110 may be made of a transparent material such as glass or a non-transparent material such as black plastics. The conductive layer 120 is disposed on the substrate 110.

The conductive layer 120 includes the sensing circuit in the touch area 100A and the peripheral wire in the circuit area 100B. The conductive layer 120 is made of a metal material, a conductive material or a combination thereof. The conductive material is such as indium tin oxide (ITO) or indium zinc oxide (IZO). In an embodiment, the touch panel 100 is a window integrated sensor (WIS) of a single-piece substrate 110, and the conductive layer 120 includes an X-axial circuit and a Y-axial circuit. In an embodiment, the touch panel 100 is a two-layered substrate 110, and the conductive layer 120 only includes the X-axial circuit or the Y-axial circuit.

The insulating layer 130 is disposed on the conductive layer 120. The insulating layer 130 may only cover the touch area 100A but exposes the circuit area 100B. In an embodiment, the insulating layer 130 may cover the entire touch area 100A and a part of the circuit area 100B but expose the electrode contact through which the circuit area 100B is electronically connected to the flexible printed circuit board 150. The insulating layer 130 is made of a transparent insulating material. The shielding layer 140 is disposed on the insulating layer 130. The shielding layer 140 is made of indium tin oxide (ITO) or indium zinc oxide (IZO). The shielding layer 140 shields the conductive layer 120 to avoid the conductive layer 120 being interfered with by other electromagnetic induction signals.

The flexible printed circuit board 150 is disposed on the conductive layer 120. The flexible printed circuit board 150 is connected to the electrode contact through an anisotropic conductive adhesive (ACP) (or anisotropic conductive film (ACF)) 160 for transmitting the touch signal sensed in the touch area 100A. The circuit area 100B is electronically connected to the conductive layer 120 through the electrode contact.

To avoid the noise interference and static electricity damaging the touch panel 100, the conductive layer 120 normally has a guard ring disposed in the circuit area 100B. The flexible printed circuit board 150 also provides a ground trace 151. When the flexible printed circuit board 150 is connected to the electrode contact disposed in the circuit area 100B of the conductive layer 120, the ground trace 151 is electronically connected to the guard ring so as to provide protection.

Referring to FIG. 1, the generally known flexible printed circuit board 550 is connected to the conductive layer 520 and the shielding layer 540 respectively, so the thermoforming process needs to be performed twice. As a result, the touch panel 500 may thus be damaged and the conformity rate is thus deteriorated. The shielding layer 140 of the present embodiment is electronically connected to the ground trace 151 of the flexible printed circuit board 150 through the conductive through hole 170, hence effectively avoiding the touch panel 100 being damaged.

In the present embodiment, one end of the flexible printed circuit board 150 is disposed on the shielding layer 140. The end of the flexible printed circuit board 150 has the conductive through hole 170 contacted the shielding layer 140 and the ground trace 151, so that the shielding layer 140 is electronically connected to the ground trace 151 through the conductive through hole 170.

That is, the flexible printed circuit board 150 is electronically connected to both the conductive layer 120 and the shielding layer 140. However, the electrical connection between the flexible printed circuit board 150 and the conductive layer 120 is different from that between the flexible printed circuit board 150 and the shielding layer 140. The flexible printed circuit board 150 is electronically connected to the conductive layer 120 by way of thermoforming the ACP (or ACF) 160. The flexible printed circuit board 150 is electronically connected to the shielding layer 140 by way of infusing a conductive plasma to the conductive through hole 170. The conductive plasma is a liquid metal of such as silver (Ag), gold (Au) or copper (Cu). Detailed processes of the manufacturing method of the touch panel 100 of the present embodiment are disclosed below.

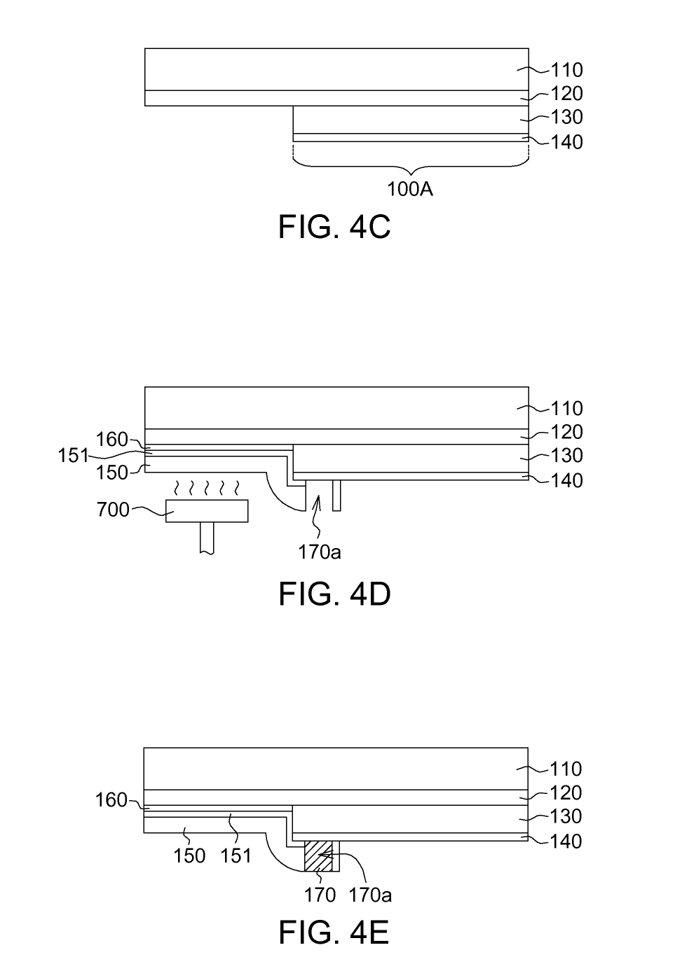

Referring to FIGS. 4A to 4E, processes illustrating a manufacturing method of a touch panel 100 according to a first embodiment are shown. First, in FIG. 4A, a substrate 110 is provided.

Next, in FIG. 4B, a conductive layer 120 is formed on the substrate 110.

Then, in FIG. 4C, an insulating layer 130 and a shielding layer 140 are disposed on the conductive layer 120, wherein the insulating layer 130 and the shielding layer 140 are mainly disposed in the touch area 100A.

Next, in FIG. 4D, a flexible printed circuit board 150 is connected to the conductive layer 120, so that the ground trace 151 is electronically connected to the conductive layer 120. In the present step, the flexible printed circuit board 150 is adhered onto the conductive layer 120 by an ACP (or ACF) 160, and one end of the flexible printed circuit board 150 is disposed on the shielding layer 140. Meanwhile, the conductive metal particles of the ACP (or ACF) 160 have not yet been melted, and the flexible printed circuit board 150 is mainly adhered to the conductive layer 120 by an adhesive.

As indicated in FIG. 4D, a thermoforming tool 700 is used for thermoforming the flexible printed circuit board 150, so that the conductive metal particles of the ACP (or ACF) 160 are melted and conducted for electronically connecting the conductive layer 120 to the ground trace 151 of the flexible printed circuit board 150.

Next, as indicated in FIG. 4E, at least one conductive through hole 170 is formed, so that the shielding layer 140 is electronically connected to the ground trace 151 of the flexible printed circuit board 150 through the conductive through hole 170. Before the present step, a via hole 170a is already formed in the flexible printed circuit board 150. A melted conductive plasma is infused to the via hole 170a, the conductive plasma is cooled, and a conductive through hole 170 is thus formed.

In the present, the diameter of the conductive through hole 170 is between 0.5 to 2 millimeters. The quantity of the conductive through hole 170 is greater than or equal to 2. That is, the conductive through hole 170 may be realized as a multi-hole structure.

As disclosed above, the shielding layer 140 is electronically connected to the ground trace 151 of the flexible printed circuit board 150 through the conductive through hole 170 without performing the thermoforming process twice. Thus, the flexible printed circuit board 150 is prevented from the damage caused by two times of thermoforming process.

### Second Embodiment

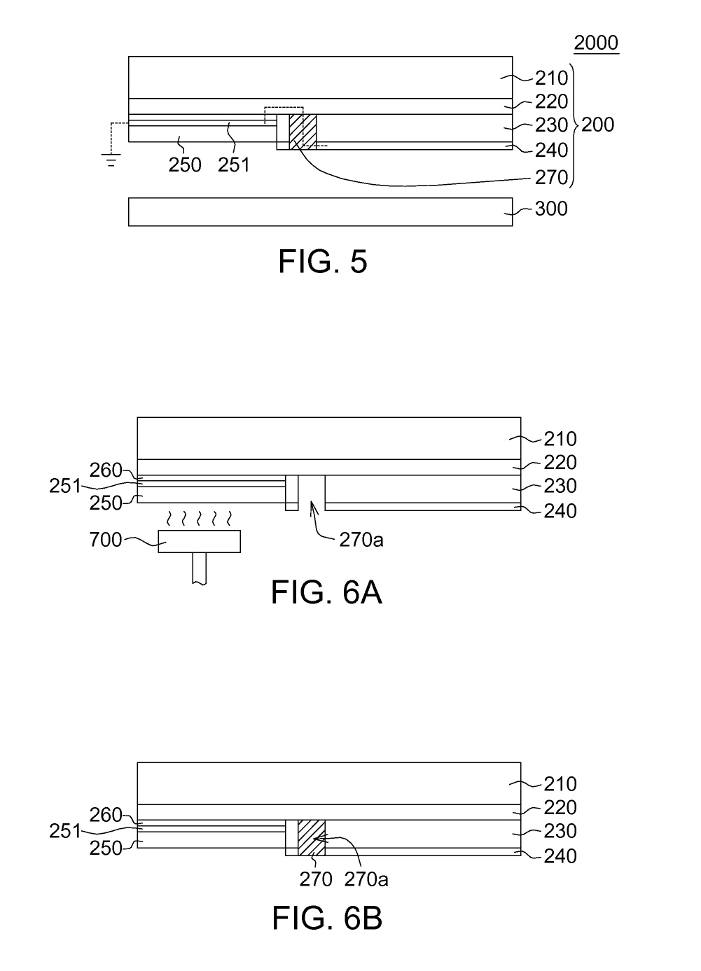

Referring to FIG. 5, a cross-sectional view of a display device 2000 according to the second embodiment is shown. The display device 2000 of the present embodiment is different from the display device 1000 of the first embodiment in the design of the conductive through hole 270, and other similarities are not repeated.

As indicated in FIG. 5, the conductive through hole 270 is formed in the insulating layer 230, and contacts the conductive layer 220 and the shielding layer 240. The conductive is electronically connected to the conductive layer 220 and the shielding layer 240 through hole 270, so that the shielding layer 240 is electronically connected to the ground trace 251 of the flexible printed circuit board 250 through the conductive through hole 270 and the conductive layer 220.

Referring to FIGS. 6A to 6B, processes illustrating a manufacturing method of a touch panel 200 according to a second embodiment are shown. First, as indicated in FIG. 6A, a substrate 210 is provided, and a conductive layer 220 is formed on the substrate 210. Next, an insulating layer 230 and a shielding layer 240 are disposed on the conductive layer 220. Then, the flexible printed circuit board 250 is adhered onto the conductive layer 220 by an ACP (or ACF) 260.

Next, the flexible printed circuit board 250 is thermoformed by a thermoforming tool 700, so that the conductive metal particles of the ACP (or ACF) 260 are melted and conducted for electronically connecting the conductive layer 220 to the ground trace 251 of the flexible printed circuit board 250.

Then, as indicated in FIG. 6B, a conductive through hole 270 is formed, so that the shielding layer 240 is electronically connected to the ground trace 251 of the flexible printed circuit board 250 through the conductive through hole 270 and the conductive layer 220. Before the present step, a via hole 270a is already formed in the insulating layer 230 and the shielding layer 240. A melted conductive plasma is infused to the via hole 270a, the conductive plasma is cooled, and a conductive through hole 270 is thus formed.

With the design of the conductive through hole 270 being disposed in the insulating layer 230 and the shielding layer 240, the thermoforming process does not need to be performed twice, and the flexible printed circuit board 250 does not need to be disposed on the shielding layer 240, and the risk of the flexible printed circuit board 250 being deformed or breaking up can thus be reduced.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch panel, comprising:
a substrate;
a conductive layer disposed on the substrate;
an insulating layer disposed on the conductive layer;
a shielding layer disposed on the insulating layer; and
a flexible printed circuit board having a ground trace electronically connected to the conductive layer,
wherein the shielding layer is electronically connected to the ground trace through at least one conductive through hole.

2. The touch panel according to claim 1, wherein one end of the flexible printed circuit board having the conductive through hole is disposed on the shielding layer, and the conductive through hole contacts the shielding layer and the ground trace, so that the shielding layer is electronically connected to the ground trace through the conductive through hole.

3. The touch panel according to claim 1, wherein the insulating layer has the conductive through hole contacted the shielding layer and the conductive layer, so that the shielding layer is electronically connected to the ground trace through the conductive through hole and the conductive layer.

4. The touch panel according to claim 1, wherein the substrate has a touch area and a circuit area, the conductive layer has a guard ring disposed in the circuit area, and the ground trace is electronically connected to the guard ring of the conductive layer.

5. The touch panel according to claim 1, wherein the quantity of the at least one conductive through hole is greater than or equal to 2.

6. The touch panel according to claim 1, wherein the diameter of the conductive through hole is between 0.5 to 2 millimeters (mm).

7. A manufacturing method of touch panel, comprising:
providing a substrate;
forming a conductive layer on the substrate;
disposing an insulating layer and a shielding layer on the conductive layer, wherein the shielding layer is disposed on the insulating layer;
connecting a flexible printed circuit board to the conductive layer, wherein the flexible printed circuit board has a ground trace electronically connected to the conductive layer; and
forming at least one conductive through hole, so that the shielding layer is electronically connected to the ground trace of the flexible printed circuit board through the conductive through hole.

8. The manufacturing method of touch panel according to claim 7, wherein in the step of connecting the flexible printed circuit board to the conductive layer, the substrate has a touch area and a circuit area, the conductive layer has a guard ring disposed in the circuit area, and the ground trace is electronically connected to the guard ring of the conductive layer.

9. The manufacturing method of touch panel according to claim 7, wherein in the step of the flexible printed circuit board, one end of the flexible printed circuit board is disposed on the shielding layer;
in the step of forming the conductive through hole, the conductive through hole is formed on the end of the flexible printed circuit board and contacts the shielding layer and the ground trace, so that the shielding layer through the conductive through hole is electronically connected to the ground trace.

10. The manufacturing method of touch panel according to claim 7, wherein in the step of forming the conductive through hole, the conductive through hole is formed in the insulating layer and contacts the shielding layer and the conductive layer, so that the shielding layer is electronically connected to the ground trace through the conductive through hole and the conductive layer.

11. The manufacturing method of touch panel according to claim 7, wherein the step of connecting the flexible printed circuit board comprises:
adhering the flexible printed circuit board on the conductive layer with an anisotropic conductive adhesive or an anisotropic conductive film; and
thermoforming the flexible printed circuit board, so that the anisotropic conductive adhesive or the anisotropic conductive film is electronically connected to the conductive layer and the ground trace.

12. The manufacturing method of touch panel according to claim 7, wherein in the step of forming the conductive through hole, the quantity of the at least one conductive through hole is greater than or equal to 2.

13. The manufacturing method of touch panel according to claim 7, wherein the step of forming the conductive through hole comprises:
infusing a melted conductive plasma to a via hole; and
cooling the conductive plasma.

14. A display device, comprising:
a display panel; and
a touch panel, comprising:
a substrate;
a conductive layer disposed on the substrate;
an insulating layer disposed on the conductive layer;
a shielding layer disposed on the insulating layer; and
a flexible printed circuit board having a ground trace electronically connected to the conductive layer,
wherein the shielding layer is electronically connected to the ground trace through at least one conductive through hole.
